(19) United States
(12) Patent Application Publication
(10) Pub. No.: US 2011/0147541 A1
(43) Pub. Date: Jun. 23, 2011

(54) CABLE STRAP LOCATING DEVICE FOR A WIRE HARNESS AND A WIRE HARNESS ASSEMBLY USING THE SAME

(75) Inventor: Matthew S. Frantz, Shakopee, MN (US)

(73) Assignee: Caterpillar Inc., Minneapolis, MN (US)

(21) Appl. No.: 12/947,154

(22) Filed: Nov. 16, 2010

Related U.S. Application Data
(60) Provisional application No. 61/289,485, filed on Dec. 23, 2009.

(51) Int. Cl. F16L 3/22; B65D 63/00; B65D 63/12; B23P 11/00

(52) U.S. Cl. 248/68.1; 24/16 R; 24/19; 29/428

(57) ABSTRACT

A cable strap locating device for a wire harness is disclosed. The device extends along an axial direction and the device includes a head and a tail. The head has a top surface, at least one side surface abutting the top surface, and an opening extending through the head and at least one side surface and substantially perpendicular to the axial direction. The tail is configured to be attached to the wire harness and extends from the head and along the axial direction.

### CLAIM FOR PRIORITY

The present application claims priority from U.S. Provisional Application Ser. No. 61/289,485, filed Dec. 23, 2006, which is fully incorporated herein.

### TECHNICAL FIELD

The present disclosure relates to a cable strap locating device for a wire harness, more particularly, to a cable strap locating device for assembling a wire harness to a required position.

### BACKGROUND

More and more electronic devices are used in machines or industrial equipment. Accordingly, wire harnesses are used to connect different electronic devices for communication between various electronic devices. These wire harnesses must be secured to certain positions within the machine for proper assembly. To ease the installation of the wire harness in a machine, wire harnesses are usually supplied by a supplier with locating tape positioned at various locations along the wire harness. The locating tape needs to be large so that workers can see it for easy assembly. Workers then use a cable strap or cable tie to secure the wire harness to the machine frame at each taped location. Due to the tape size, the actual position that the cable strap secures the wire harness to the machine may vary. In addition, as the machine vibrates, the electronic component attached to the wire harness at the taped location may be stressed. Therefore, it is desired to have a device that not only can provide a locating identifier for assembly, but also provide increased stress relief.

The present disclosure is directed to solutions to provide a cable strap locating device and a cable strap assembly method using the device, and to overcoming one or more of the deficiencies set forth above.

### SUMMARY OF THE DISCLOSURE

In one aspect, the present disclosure is directed to a cable strap locating device for a wire harness. The device extends along an axial direction and the device includes a head and a tail. The head has a top surface, at least one side surface abutting the top surface, and an opening extending through the head and into the at least one side surface and substantially perpendicular to the axial direction. The tail is configured to be attached to the wire harness and extends from the head and along the axial direction.

In another aspect, the present disclosure is directed to a wire harness assembly. The wire harness assembly includes a plurality of wires, a sheath, and a cable strap locating device. The plurality of wires extends along an axial direction. The sheath at least partially covers the plurality of wires. The cable strap locating device is attached to the sheath along the axial direction and has a head and a tail. The head has a top surface, at least one side surface abutting the top surface, and an opening extending through the head and into the at least one side surface and substantially perpendicular to the axial direction. The tail is configured to be attached to the sheath and extends from the head and along the axial direction.

In yet another aspect, the present disclosure is directed to a method for securing a wire harness to a machine. The method includes the step of providing a plurality of wires extending along an axial direction having a sheath at least partially covering the plurality of wires. The method also includes the step of providing a cable strap locating device having a head with a top surface, at least one side surface abutting the top surface, and an opening extending through the head and into the at least one side surface and substantially perpendicular to the axial direction, and a tail extending from the head and along the axial direction. The method also includes the step of attaching the tail to the plurality of wires. The method also includes the step of attaching the cable strap locating device to the machine.

### BRIEF DESCRIPTION OF THE DRAWINGS

FIG. 1 is a perspective view of the wire harness assembly of the present disclosure shown secured to a machine frame.

FIG. 2 is a partially exploded view of the wire harness assembly and cable strap locating device of the present disclosure.

FIG. 3 is a side view of the cable strap locating device of the present disclosure.

FIG. 4 is a perspective view of the wire harness assembly shown attached to a machine component through a connector.

FIG. 5 is a side view of another embodiment of the cable strap locating device of the present disclosure.

### DETAILED DESCRIPTION

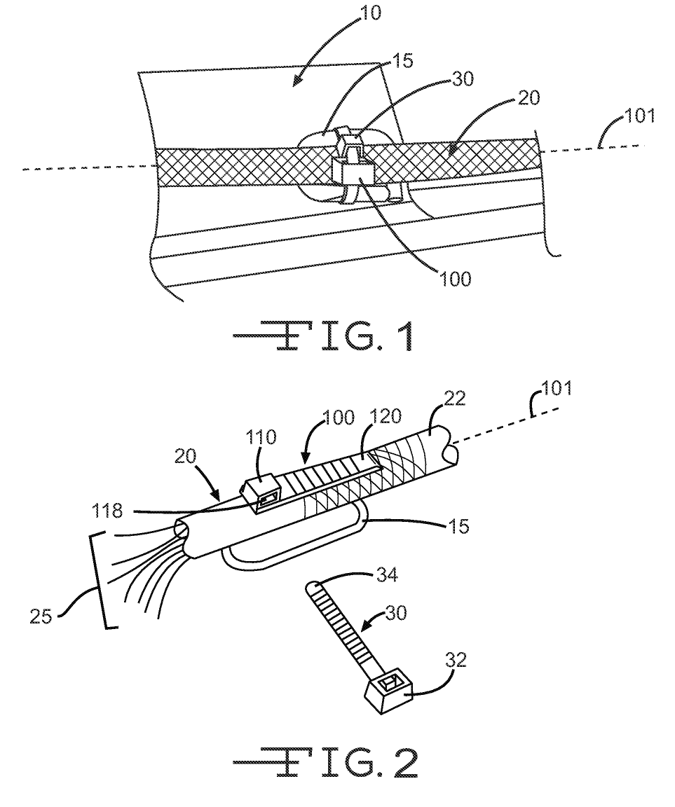

FIG. 1 illustrates a wire harness assembly 20 according to the present disclosure. The wire harness assembly 20 is shown attached to a weld link 15 of a machine frame 10. The machine frame 10 may be part of a stationary or mobile machine, vehicle, or piece of equipment having a plurality of electronic machine components 18 (one shown in FIG. 4). The wire harness assembly 20, extending along an axial direction 101, includes a cable strap locating device 100 and a cable strap 30. The cable strap 30 is shown securing the wire harness assembly 20 to the weld link 15 through the cable strap locating device 100.

As seen in FIG. 2, the cable strap locating device 100 includes a head 110, a tail 120, and an opening 118 extending through the head 110. The tail 120 extends along the axial direction 101. The tail 120 is attached to a sheath 22 of the wire harness assembly 20. The sheath 22 may be a braided mesh wire or tape surrounding a plurality of wires 25 also extending along the axial direction 101. The length of the tail 120, along the axial direction 101, may be sized such that at least two independent wraps of a tape, placed side by side and wrapped perpendicular to the axial direction 101, such as a polyvinyl chloride tape, extend over the tail 120 as the cable strap locating device 100 is secured to the sheath 22. The sheath 22 may be used to partially or fully cover the wire harness assembly 20. Looming (not shown), may then be applied over the sheath 22 and tail 120, leaving the head 110 exposed. Alternately, the tail 120 may be attached directly to the plurality of wires 25, with looming then applied over the plurality of wires 25 and the tail 120, leaving the head 110 exposed. In such a case the looming may be considered the sheath.

The cable strap 30 includes a head end 32 and a tail end 34. As is known in the art, the tail end 34 of the cable strap 30 is configured to be inserted into the head end 32 and locked with a ratcheting mechanism (not shown) or other locking mechanism (not shown). In the wire harness assembly 20, the tail end 34 is inserted into the opening 118 and wraps around the wire harness assembly 20 and weld link 15 before being engaging the head end 32.

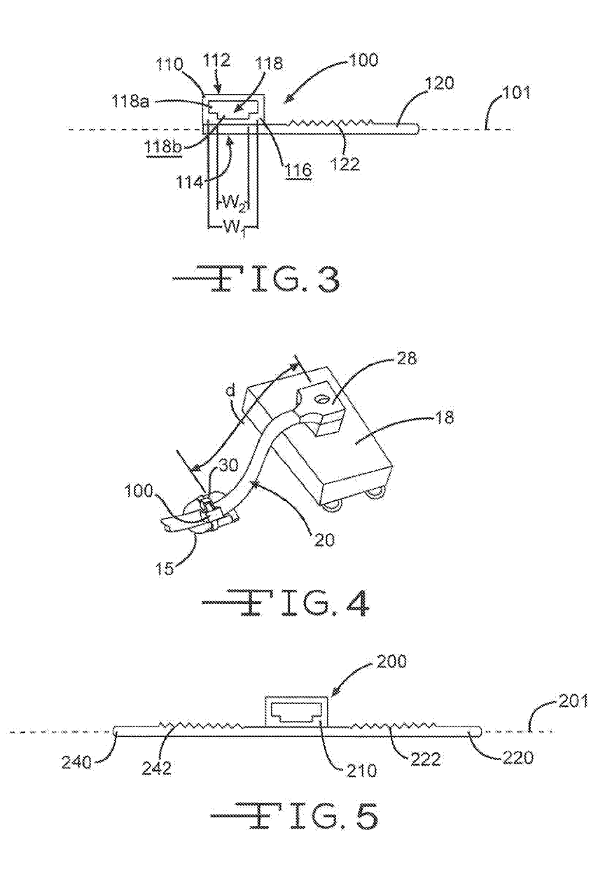

As best seen in FIG. 3, the head 110 of the cable strap locating device 100 includes a top surface 112, a bottom surface 114, and a side surface 116. The bottom surface 114 is opposite the top surface 112 and adjacent the side surface 116 and is configured to be positioned on the wire harness assembly 20. The bottom surface 114 may include grooves (not shown) or be curved to facilitate engagement with the wire harness assembly 20. The side surface 116 abuts the top surface 112 and includes the opening 118. The opening 118 extends through the head 110 and into the side surface 116. The opening 118 also extends substantially perpendicular to the axial direction 101. The opening 118 may include a first portion 118a and a second portion 118b. The first portion 118a has a width “W1” and the second portion 118b has a width “W2.” W1 is sized to accommodate the width of a cable strap 30 having a tail end 34 with a width less than W1, and W2 is sized to accommodate a different cable strap 30 having a tail end 34 with a width less than W2. This stepped arrangement of the opening 118 allows a single cable strap locating device 100 to positively locate two different widths of cable straps 30. Alternately, the opening 118 may have a uniform width or more than two portions, each portion having a different width.

The tail 120 is shown with a plurality of grooves 122 extending perpendicular to the axial direction 101. The plurality of grooves 122 may help fix the tape (not shown) used to secure the cable strap locating device 100 to the sheath 22.

FIG. 4 illustrates a terminal connection of the wire harness assembly 20. The wire harness assembly 20 is shown terminating in a connector 28. The connector 28 is in electrical communication with a machine component 18. The machine component 18 is an electronic device such as an electronic control module. On the wire harness assembly 20, the cable strap locating device 100 is positioned a distance “d” away from the connector 28. The distance “d” is dimensioned to permit adequate slack in the wire harness assembly 20 such that when a cable strap 30 secures the wire harness assembly 20 to the weld link 15 through the cable strap locating device 100, the connector 28 has enough slack to be plugged and unplugged into the machine component 18. As can be appreciated, positioning a cable strap locating device 100 near a connector 28 may make it easier to control stress at important connections such as to an electronic control module.

The cable strap locating device 100 may be formed by injection molding a plastic, such as polyamide nylon 66 (“PA66”). With a die draw done perpendicular to the axial direction 101, undercuts may be avoided and the cable strap locating device 100 may be manufactured cheaply. The color of the plastic may be chosen to highlight the device, such as white or some color that contrasts with the color of the sheath 22, making it easier for the assembly worker to see. The color of the plastic may also be chosen to make the device inconspicuous, such as black or a color similar to the color of the sheath 22.

FIG. 5 illustrates another embodiment of a cable strap locating device 200. The cable strap locating device 200 includes a head 210, a first tail 220, and a second tail 240. The first and second tails 220, 240 extend from the head 210 along the axial direction 201 in opposite directions. The first and second tails 220, 240 may each include grooves 222, 242. Each of the first and second tails 220, 240 may be secured to the braided mesh wire or tape of the sheath 22 with tape as described above. Other aspects of the cable strap locating device 200 are similar to the cable strap locating device 100.

### INDUSTRIAL APPLICABILITY

The present disclosure finds application in a cable strap locating device for assembling a wire harness to a machine frame. The present disclosure may generally be applied to a wire harness assembly, where some tolerance or accuracy about the wire harness length, such as in a machine, electronic device or other equipment is required. The cable strap locating device allows for precisely setting the position of a cable strap on the finished wire harness as it is assembled to a machine.

While the positional tolerance of the weld links 15 or other fixing devices of the machine frame 10 must be accounted for, the cable strap locating device 100, 200 allows a harness supplier to accurately set the position of the cable strap 30 on the finished wire harness assembly 20. Because the harness supplier can position the cable strap locating device 100, 200 to the wire harness assembly 20 before it is loomed and while it is in a controlled factory setting, the position can be controlled very accurately. This cable strap locating device 100, 200 then allows a positively located, consistent cable strap location on the wire harness. With the head 110 sticking out of the wire harness, it may prove easier for a worker to locate the fastening position than with a piece of colored tape, increasing assembly efficiency. This reduces problems related to improper assembly of the harness by a factory assembly worker. It also avoids harness failures due to the cable strap rubbing through the sheath and wire insulation, connectors with intermittent connections, mating parts that do not fit, and bad aesthetics. Moreover, the cable strap can be easily removed and the cable strap locating device 100, 200 may remain and be reused.

It should be understood that the above description is intended for illustrative purposes only, and is not intended to limit the breadth of the present disclosure in any way. Thus, those skilled in the art will appreciate that various modifications might be made to the presently disclosed embodiments without departing from the full and fair scope of the present disclosure. Other aspects, features and advantages can be obtained from a study of the drawings, and the appended claims.

What is claimed is:

1. A cable strap locating device for a wire harness, the wire harness extending along an axial direction, comprising:
a head having a top surface, at least one side surface abutting the top surface, and an opening extending through the head and into the at least one side surface and substantially perpendicular to the axial direction; and
a tail, configured to be attached to the wire harness, extending from the head and along the axial direction.

2. The cable strap locating device of claim 1, wherein the opening has a first portion with a first width and a second portion with a second width, the second width less than the first width.

3. The cable strap locating device of claim 1, wherein the head has a bottom surface adjacent to the at least one side surface, opposite the top surface, and configured to be positioned on the wire harness.

4. The cable strap locating device of claim 1, wherein the tail has a plurality of grooves.

5. The cable strap locating device of claim 1, wherein the tail is a first tail and further comprising:
a second tail extending from the head along the axial direction and opposite the first tail, the second tail configured to be attached to the wire harness.

6. The cable strap locating device of claim 1, wherein the cable strap locating device is made of plastic.

7. A wire harness assembly comprising:
a plurality of wires extending along an axial direction;
a sheath at least partially covering the plurality of wires; and
a cable strap locating device attached to the sheath along the axial direction and having:
a head having a top surface, at least one side surface abutting the top surface, and an opening extending through the head and into the at least one side surface and substantially perpendicular to the axial direction; and
a tail, configured to be attached to the sheath, extending from the head and along the axial direction.

8. The wire harness assembly of claim 7, further comprising:
a cable strap positioned through the opening and configured to secure the cable strap locating device and the plurality of wires to a machine frame.

9. The wire harness assembly of claim 7, wherein the opening has a first portion with a first width and a second portion with a second width, the second width less than the first width.

10. The wire harness assembly of claim 7, wherein the head has a bottom surface adjacent to the at least one side surface, opposite the top surface, and configured to be positioned on the plurality of wires.

11. The wire harness assembly of claim 7, wherein the tail has a plurality of grooves.

12. The wire harness assembly of claim 7, wherein the tail is a first tail and further comprising:
a second tail extending from the head along the axial direction and opposite the first tail, the second tail configured to be attached to the sheath.

13. The wire harness assembly of claim 7, wherein the cable strap locating device is made of plastic.

14. A method for securing a wire harness to a machine, comprising the steps of:
providing a plurality of wires extending along an axial direction having a sheath at least partially covering the plurality of wires;
providing a cable strap locating device having a head with a top surface, at least one side surface abutting the top surface, and an opening extending through the head and into the at least one side surface and substantially perpendicular to the axial direction, and a tail extending from the head and along the axial direction;
attaching the tail to the sheath; and
attaching the cable strap locating device to the machine.

15. The method of claim 14, wherein the step of attaching the cable strap locating device to the machine includes positioning a cable strap through the opening and around a portion of a machine frame.

16. The method of claim 14, wherein the tail is a first tail and the cable strap locating device includes a second tail extending from the head along the axial direction and opposite the first tail, and further including the step of:
attaching the second tail to the sheath.
